(19) United States
(12) Patent Application Publication
(10) Pub. No.: US 2014/0063059 A1
(43) Pub. Date: Mar. 6, 2014

(54) INTERACTIVE AUGMENTED REALITY SYSTEM AND PORTABLE COMMUNICATION DEVICE AND INTERACTION METHOD THEREOF

(71) Applicant: COMPAL COMMUNICATION, INC., Neihu (TW)

(72) Inventor: Kuo-Hung Chiang, Neihu (TW)

(73) Assignee: COMPAL COMMUNICATION, INC., Neihu (TW)

(21) Appl. No.: 13/744,779

(22) Filed: Jan. 18, 2013

(30) Foreign Application Priority Data
Aug. 28, 2012 (TW) 101131194

(51) Int. Cl. G09G 5/377

(52) U.S. Cl. CPC G09G 5/377
USPC 345/633

(57) ABSTRACT

An interactive augmented reality system includes an interactive object and a portable communication device. The communication device includes a control module, an image capture module and a communication module. The control module controls and operates the portable communication device and the interactive object. The image capture module is connected with the control module to capture an image of the interactive object. The communication module is connected with the control module to exchange information with interactive object. The control module computes and rebuilds the image, and then overlays the image on a virtual scene generated by the control module. As a result, an augmented reality image is generated, and an action signal is transmitted to the interactive object by the portable communication device, such that the interactive object executes a preset action according to the action signal. The system attracts users, reduces the operation difficulty, and enhances the user experiences.

### FIELD OF THE INVENTION

The present invention relates to a system, and more particularly to an interactive augmented reality system and portable communication device and interaction method thereof.

### BACKGROUND OF THE INVENTION

With growing of information technologies, the consumer electronics grows in incredible time. To match the requirements of users, a lot of types of the portable communication device are produced (e.g. a smart phone, a handheld game console, a tablet PC, a notebook PC, a personal digital assistant and a pocket PC). The portable communication device and the applications installed therein not only enhance the working efficiency, but also bring more joys in life.

In recent years, the augmented reality technology is popularly used in entertainment, education and business occasions. Take the traditional augmented reality technology for example, an image of a static object in the real world is captured by an image capture device of a portable communication device like a photosensitive element, and then overlapped with a stage in the imaginary world. The applications of the augmented reality technology are like that capturing buildings to demonstrate the guiding of a city or capturing people to accomplish the role-playing of an imaginary world.

However, the traditional augmented reality technology is passive augmented reality technology, which means that the static object in the real world added into the imaginary world is a passive object, which cannot participate the interaction between a user and the augmented reality system. In other words, in the processes of the interaction between the user and the augmented reality system, the entire active role is the user, the imaginary scene or the imaginary object. Under this circumstance, the user may feel bored because of the unchanged behavior and scene, and will not be interested in it. Additionally, the user has to think himself/herself about selecting a static object in the real world or choosing an object to interact with. Not only the operation is difficult and complicate, but also the user experiences are poor and bad.

There is a need of providing an interactive augmented reality system and portable communication device and interaction method thereof to obviate the drawbacks encountered from the prior art.

### SUMMARY OF THE INVENTION

The present invention provides an interactive augmented reality system and portable communication device and interaction method thereof in order to eliminate the drawbacks caused by the passive augmented reality technology (e.g. difficult operation, poor user experiences and low attractiveness).

The present invention also provides an interactive augmented reality system and portable communication device and interaction method thereof. The interactive augmented reality system utilizes a portable communication device having a control module to control and operate both the portable communication device and an interactive object, so that the interactive object actively participates the interaction between a user and the interactive augmented reality system to enhance the attractiveness and the user experiences.

The present invention further provides an interactive augmented reality system and portable communication device and interaction method thereof. Via computing, identifying and tracking of the control module of the portable communication device, a lot of types of interactive object are identified. As a result, any kind of the interactive object is chose by a user to interact with, such that the operation difficulty is reduced and the user experiences are enhanced.

In accordance with an aspect of the present invention, there is provided an interactive augmented reality system. The interactive augmented reality system includes an interactive object and a portable communication device. The portable communication device comprises a control module, an image capture module and a communication module. The interactive object and the portable communication device are controlled by the control module. The image capture module is connected with the control module to capture an image of the interactive object. The communication module is connected with the control module to exchange information with the interactive object. The control module computes and rebuilds the image, and then overlays the image on a virtual scene generated by the control module to generate an augmented reality image. An action signal is transmitted to the interactive object by the communication module, such that the interactive object executes a preset action according to the action signal.

In accordance with another aspect of the present invention, there is provided a portable communication device of an interactive augmented reality system comprising an interactive object. The portable communication device comprises a control module, an image capture module and a communication module. The image capture module is connected with the control module to capture an image of the interactive object. The communication module is connected with the control module to exchange information with the interactive object. The control module computes and rebuilds the image, and then overlays the image on a virtual scene generated by the control module to generate an augmented reality image. An action signal is transmitted to the interactive object by the communication module, such that the interactive object executes a preset action according to the action signal.

In accordance with still another aspect of the present invention, there is provided an interaction method. The interaction method comprises steps as following: providing a portable communication device and an interactive object; allowing the portable communication device to capture an image of the interactive object; allowing said portable communication device to compute and rebuild the image and overlay the image on a virtual scene to generate an augmented reality image; and allowing the portable communication device to transmit an action signal to the interactive object, such that the interactive object executes a present action according to the action signal.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the configuration of an interactive augmented reality system according to an embodiment of the present invention;

FIG. 2 schematically illustrates the detailed configuration of the portable communication device as shown in FIG. 1;

FIG. 3 schematically illustrates an interaction flow diagram of an interactive augmented reality system according to an embodiment of the present invention;

FIG. 4 schematically illustrates the structure of an interactive object according to an embodiment of the present invention;

FIG. 5 schematically illustrates the augmented reality image of the interactive augmented reality system; and

FIG. 6 schematically illustrates a flow chart of the interaction method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

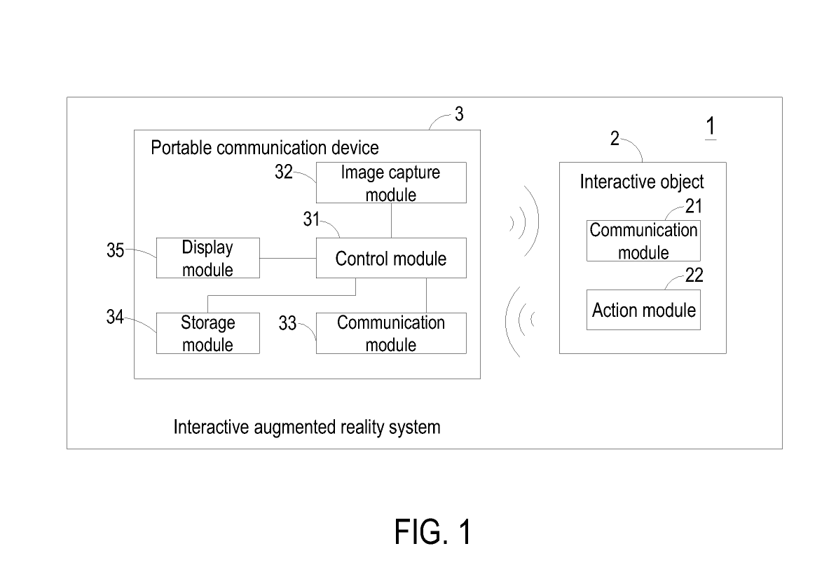

Please refer to FIG. 1. FIG. 1 schematically illustrates the configuration of an interactive augmented reality system according to an embodiment of the present invention. The interactive augmented reality system 1 at least comprises an interactive object 2 and a portable communication device 3. The interactive object 2 is an object in the real world and is for example a robot, a remote control helicopter or a telephone, but not limited thereto. The portable communication device 3 comprises a control module 31, an image capture module 32 and a communication module 33. An example of the portable communication device 3 includes but is not limited to a smart phone, a tablet PC, a notebook PC, a handheld game console, a PDA and a pocket PC. The interactive object 2 and the portable communication device 3 are controlled and operated by the control module 31. Preferably, the interactive object 2 is controlled and operated by the control module 31 through the communication module 33. The image capture module 32 is not limited to a photosensitive element, a webcam or a digital camera and is connected with the control module 31 to capture an image of the interactive object 2. The communication module 33 is connected with the control module 31 to exchange information with the interactive object 2. In one embodiment, the communication module 33 may comprise a Bluetooth chip, a Wi-Fi chip, or a RFID chip, but is not limited thereto. The control module 31 computes and rebuilds the image, and then overlays the image, which has been computed and rebuilt, on a virtual scene generated by the control module 31 to generate an augmented reality image. An action signal is transmitted to the interactive object 2 by the communication module 33, such that the interactive object 2 executes a preset action according to the action signal. As a result, the interactive object 2 of the present invention actively participates the interaction between a user and the interactive augmented reality system 1 to enhance the attractiveness and the user experiences.

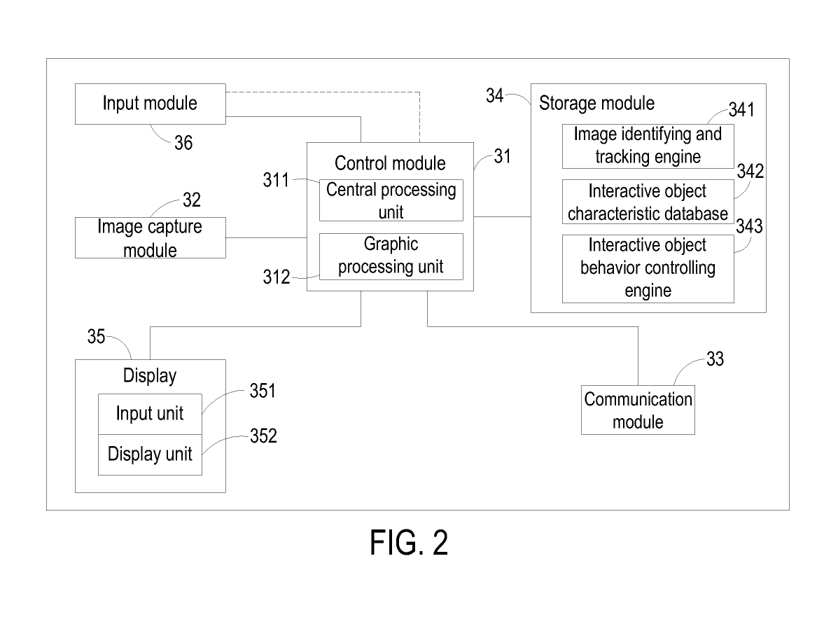

Please refer to FIG. 2. FIG. 2 schematically illustrates the detailed configuration of the portable communication device as shown in FIG. 1. The control module 31 of the portable communication device 3 further comprises a central processing unit (hereinafter “CPU”) 311 and a graphic processing unit (hereinafter “GPU”) 312. The GPU 312 works with the functions as image computing, image rebuilding and image drafting. The CPU 311 works with the functions as controlling, operating and computing and may further help the GPU 312 to complete parts of image computing, image rebuilding and image drafting.

In some embodiments, the portable communication device 3 further includes a storage module 34, a display module 35 and an input module 36. The storage module 34 is connected with the control module 31 and is not limited to a RAM, a hard-drive disk, a flash memory or a solid-state disk. An image identifying and tracking engine 341, an interactive object characteristic database 342 and an interactive object behavior controlling engine 343 are packed into same application or different applications and stored in the storage module 34 to be preloaded by the control module 31 for computing and operating. On the other hand, the display module 35 is connected with the control module 31 to display the augmented reality image generated by the control module 31, but not limited thereto. The input module 36 has a wired connection or a wireless connection with the control module 31 and is for example a Bluetooth keyboard, an USB keyboard, a Mini-USB keyboard or a Micro-USB keyboard, which is provided for a user to input commands or messages into the control module 31.

Moreover, the display module 35 of the portable communication device 3 further comprises an input unit 351 and a display unit. The input unit 351 is for example a touch interface and the display unit 352 is for example a liquid crystal display panel or a plasma panel, but not limited thereto. In some embodiments, the input unit 351 and the display unit 352 are integrated as a touch panel, so that the augmented reality image generated by the control module 31 is displayed on the display module 35 at the same time that the display module 35 is provided to be operated or inputted commands or messages into the control module 31 for a user. Certainly, the augmented reality image generated by the control module 31 can also be transmitted to other electronic devices or other display devices to be displayed, which means that the augmented reality image can be displayed not only on the portable communication device 3, but also on the other devices, as which the present invention teaches.

Please refer to FIG. 1 again. In this embodiment, the interactive object 2 of the interactive augmented reality system 1 further comprises a communication module 21 and an action module 22. The communication module 21 of the interactive object 2 is wirelessly communicated with the communication module 33 of the portable communication device 3 to receive the action signal and comprises a Bluetooth chip, a Wi-Fi chip or a RFID chip. The communication module 21 of the interactive object 2 is connected with the action module 22 to transmit the action signal transmitted by the communication module 33 of the portable communication device 3 to the action module 22, so that the action module 22 executes a preset action according to the action signal. The preset action is for example dodging, poking, shooting, jumping, pitching, moving, hand-raising, clapping, sitting, squatting, lying, shouting, laughing, crying or pausing, but not limited thereto.

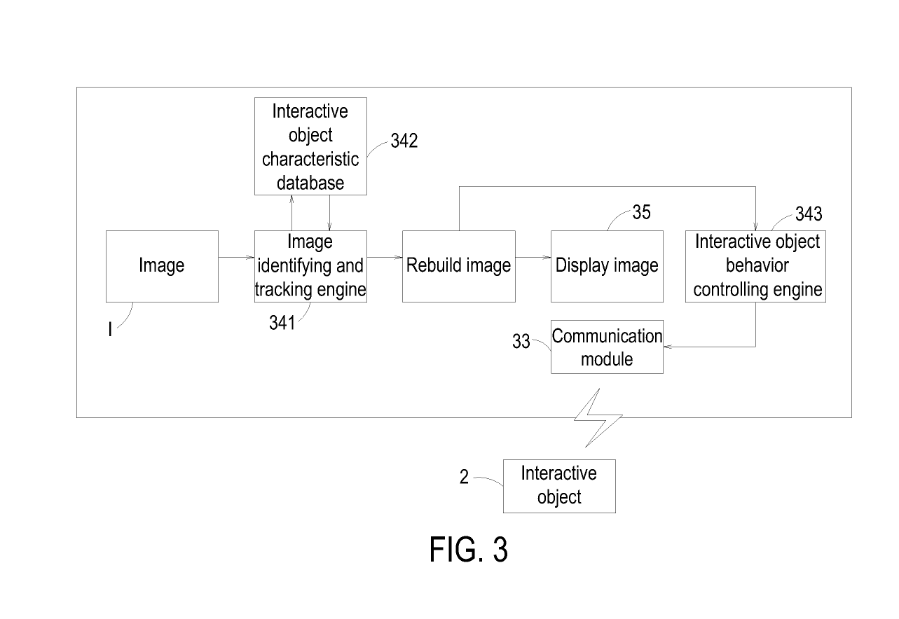

Please refer to FIGS. 1, 2 and 3. FIG. 3 schematically illustrates an interaction flow diagram of an interactive augmented reality system according to an embodiment of the present invention. An image I of the interactive object 2 is captured by the image capture module 32 of the portable communication device 3 of the interactive augmented reality system 1 of the present invention and transmitted to the control module 31, which is preloaded with the image identifying and tracking engine 341 and the interactive object behavior controlling engine 343. After receiving the image I, the control module 31 starts the image identifying and tracking engine 341 to identify the image I, and then compares the result of identification with the object characteristic data of the interactive object characteristic database 342 stored in the storage module 34. After checking the object type of the interactive object 2 according to the result of comparison, the control module 31 starts image tracking to trace the interactive object 2, rebuilds the image I, and overlays the image I on a virtual scene computed and generated by the control module 31 to generate an augmented reality image. The augmented reality image is then transmitted to the display module 35 to be displayed.

Simultaneously, the control module 31 starts the preloaded interactive object behavior controlling engine 343 to generate and send an action signal to the communication module 33 according to the result of image tracking and image rebuilding. The action signal is transmitted to the interactive object 2 by the communication module 33 of the portable communication device 3. After receiving the action signal, the communication module 21 of the interactive object 2 transmits the action signal to the action module 22, so that the action module 22 executes the preset action corresponding to the action signal. It can be seen that a lot of types of interactive object 2 are identified via computing, image identifying and image tracking of the control module 31 of the portable communication device 3. Under this circumstance, a user may choose any kind of the interactive object 2 to interact with, such that the operation difficulty is reduced and the user experiences are enhanced under the concept of the present invention.

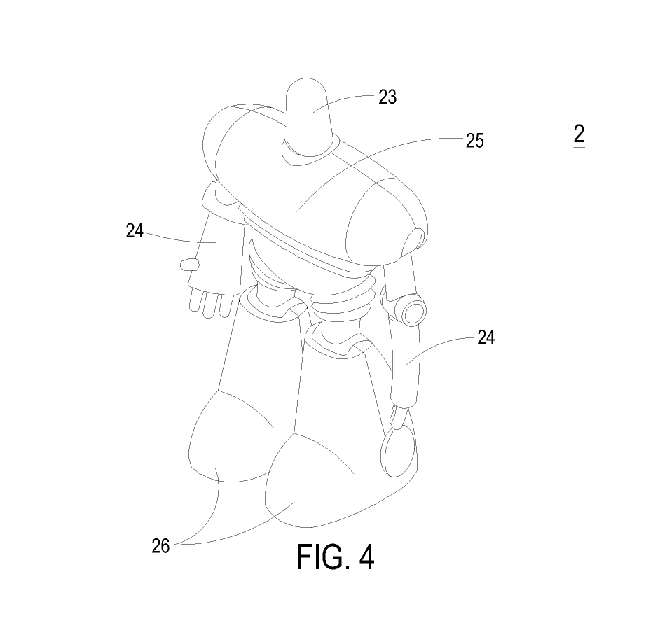

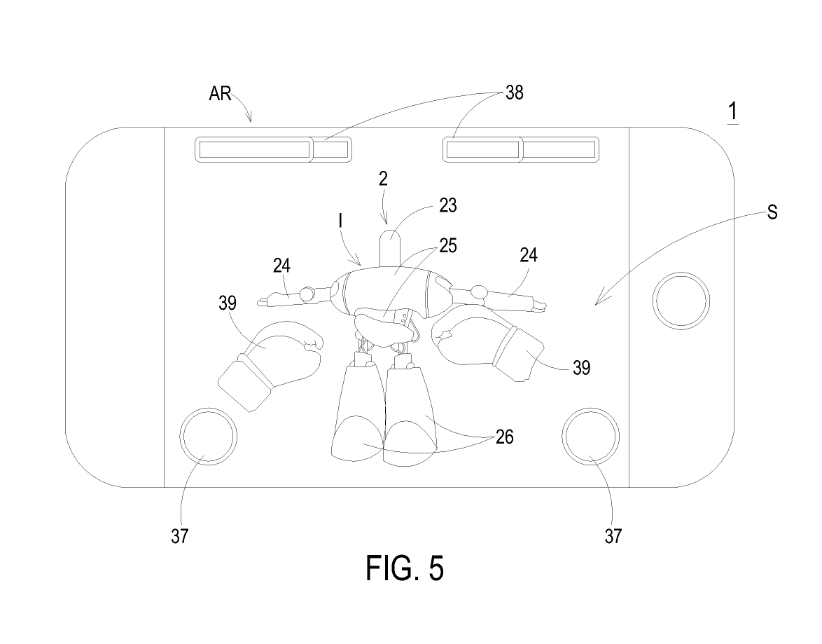

Please refer to FIGS. 1, 4 and 5. FIG. 4 schematically illustrates the structure of an interactive object according to an embodiment of the present invention. FIG. 5 schematically illustrates the augmented reality image of the interactive augmented reality system. As shown in FIGS. 1, 4 and 5, the interactive object 2 of the interactive augmented reality system 1 of the present invention can be a humanoid object (e.g. a robot). In this embodiment, the interactive object 2 has a head 23, a hand 24, a body 25 and a foot 26, which are all connected with the action module 22 to implement the above-mentioned preset action according to the action signal. As the embodiment mentioned above, the image I of the interactive object 2 is captured by the image capture module 32 of the portable communication device 3 and computed and rebuilt by the control module 31. An augmented reality image AR is then generated by the control module 31 after overlaying the rebuilt image I on the virtual scene S computed and generated by the control module 31.

In some embodiments, the portable communication device 3 further comprises a plurality of virtual buttons 37, at least one virtual icon 38 and at least one virtual object 39. The virtual buttons 37, the virtual icon 38 and the virtual object 39 are displayed on the display module 35. The virtual buttons 37 are corresponded with a plurality of actions executed by the virtual object 39 in the augmented reality image AR, so that a user may control the virtual object 39 to implement the actions in the augmented reality image AR by single-clicking, double-clicking, sliding, dragging or doing any other gesture on the virtual buttons 37. For example, the virtual object 39 can be controlled to attack the body 25 of the interactive object 2 on the image I. In addition, the virtual icon 38 is displayed as information of the interactive object 2 and/or the user (e. g. a health bar or a life bar), but not limited thereto.

In this embodiment, when the body 25 of the interactive object 2 on the image I of the augmented reality image AR is attacked as aforementioned, the control module 31 of the portable communication device 3 chooses the action signal corresponding to the action of shouting or lying form the interactive object behavior controlling module 343 and transmits the action signal to the interactive object 2, such that the interactive object 2 executes the action of shouting or lying according to the action signal. As a result, the present invention achieves the advantages of situational interacting.

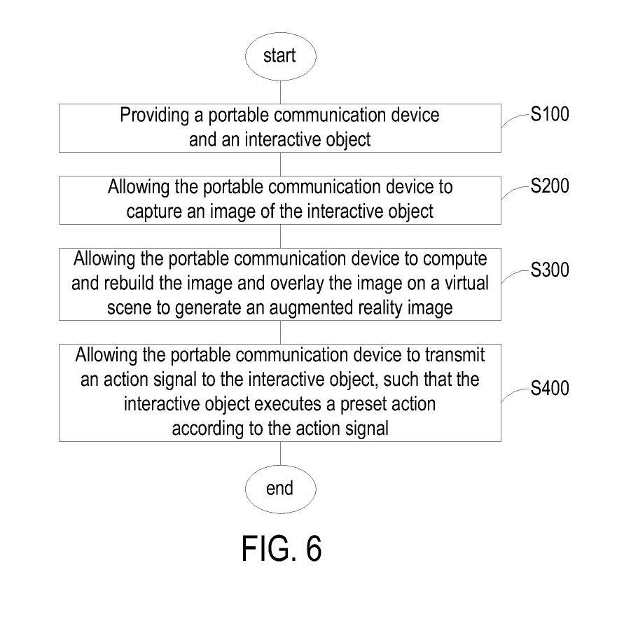

Please refer to FIG. 6. FIG. 6 schematically illustrates a flow chart of the interaction method according to an embodiment of the present invention. The interaction method of the present invention includes steps as following: at first, providing an interactive object 2 and a portable communication device 3 as shown in step S100; next, allowing the portable communication device 3 to capture an image of the interactive object 2 as shown in step S200; next, allowing the portable communication device 3 to compute and rebuild the image and overlay the image on a virtual scene to generate an augmented reality image as shown in the step S300; and allowing the portable communication device 3 to transmit an action signal to the interactive object 2 as shown in step S400, such that the interactive object executes a preset action according to the action signal. In this embodiment, the characteristics, the configurations and the structures of the interactive object 2 and the portable communication device 3 are similar to those of the interactive augmented reality system of the embodiment mentioned above, and are not redundantly described herein.

From the above description, the present invention provides an interactive augmented reality system and portable communication device and interaction method thereof. The interactive augmented reality system utilizes a portable communication device having a control module to control and operate both the portable communication device and an interactive object, so that the interactive object actively participates the interaction between a user and the interactive augmented reality system to enhance the attractiveness and the user experiences. On the other hand, via computing, identifying and tracking of the control module of the portable communication device, a lot of types of interactive object are identified. As a result, any kind of the interactive object is chose by a user to interact with, such that the operation difficulty is reduced and the user experiences are enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An interactive augmented reality system, comprising:
an interactive object; and
a portable communication device, comprising:
a control module, wherein said interactive object and said portable communication device are controlled by said control module;
an image capture module connected with said control module to capture an image of said interactive object; and
a communication module connected with said control module to exchange information with said interactive object,
wherein said control module computes and rebuilds said image, then overlays said image on a virtual scene generated by said control module to generate an augmented reality image, and an action signal is transmitted to said interactive object by said communication module, such that said interactive object executes a preset action according to said action signal.

2. The interactive augmented reality system according to claim 1 wherein said portable communication device further comprises a storage module comprising an image identifying and tracking engine, an interactive object characteristic database and an interactive object behavior controlling engine stored in said storage module, wherein object characteristic data are stored in said interactive object characteristic database, and said action signal corresponding to said preset action is stored in said interactive object behavior controlling engine.

3. The interactive augmented reality system according to claim 2 wherein said image identifying and tracking engine, said interactive object characteristic database and said interactive object behavior controlling engine are packed into same application or different applications.

4. The interactive augmented reality system according to claim 1 wherein said portable communication device further comprises a display module comprising an input unit and a display unit.

5. The interactive augmented reality system according to claim 4 wherein said input unit and said display unit are integrated as a touch panel.

6. The interactive augmented reality system according to claim 4 wherein said portable communication device further comprises a plurality of virtual buttons, at least one virtual icon and at least one virtual object, and wherein said virtual buttons, said virtual icon and said virtual object are displayed on said display module.

7. The interactive augmented reality system according to claim 6 wherein said virtual buttons are corresponded with a plurality of actions executed by said virtual object in said augmented reality image, and wherein said virtual icon is displayed as information of said interactive object and a user.

8. The interactive augmented reality system according to claim 1 wherein said interactive object further comprises a communication module and an action module, wherein said communication module of said interactive object is wirelessly communicated with said communication module of said portable communication device to receive said action signal, and wherein said action module is connected with said communication module of said interactive object to execute said preset action according to said action signal.

9. A portable communication device of an interactive augmented reality system comprising an interactive object, comprising:
a control module; and
an image capture module connected with said control module to capture an image of said interactive object; and
a communication module connected with said control module to exchange information with said interactive object,
wherein said control module computes and rebuilds said image, then overlays said image on a virtual scene generated by said control module to generate an augmented reality image, and an action signal is transmitted to said interactive object by said communication module, such that said interactive object executes a preset action according to said action signal.

10. An interaction method, comprising steps:
providing a portable communication device and an interactive object;
allowing said portable communication device to capture an image of said interactive object;
allowing said portable communication device to compute and rebuild said image and overlay said image on a virtual scene to generate an augmented reality image; and
allowing said portable communication device to transmit an action signal to said interactive object, such that said interactive object executes a preset action according to said action signal.
